(19) United States
(12) Patent Application Publication
(10) Pub. No.: US 2026/0148591 A1
(43) Pub. Date: May 28, 2026

(54) PARKING CONTROL SYSTEM

(71) Applicant: MindIT Holdings, LLC., Delray Beach, FL (US)

(72) Inventors: Rudy Romeiro, Boca Raton, FL (US); Catalina Bui, Dallas, TX (US)

(21) Appl. No.: 19/398,993

(22) Filed: Nov. 24, 2025

Related U.S. Application Data
(60) Provisional application No. 63/724,798, filed on Nov. 25, 2024.

(51) Int. Cl. G07B 15/02; G06Q 20/32; G06Q 20/34; G06V 20/62; H04N 23/90

(52) U.S. Cl. CPC G07B 15/02; G06V 20/625; G06Q 20/326; G06Q 20/3278; G06Q 20/352; G06V 2201/08; H04N 23/90

(57) ABSTRACT

A parking control system for authorizing parking of a vehicle within a geographic area includes: an integrated smart sign, including: a display configured to display information; at least one camera configured to receive image data, the image data including an imaged customer license plate number; communication circuitry configured to transmit signals to a remote processor; a near field communication (NFC) reader configured to receive a payment signal from one of a mobile device or a payment card, wherein the payment signal includes payment information; and a processor configured to communicate with the display, the at least one camera, and the communication circuitry, wherein the processor is configured to cause the display to display payment instructions including requesting a customer to enter an entered customer license plate number, and wherein the processor is configured to cause the communication circuitry to transmit the imaged customer license plate number, the entered customer license plate number, and the payment information to a remote processor.

### CROSS REFERENCE TO RELATED APPLICATIONS

The present application claims the benefit of U.S. Prov. No. 63/724,798, filed on Nov. 25, 2024, the entirety of which is incorporated by reference herein.

### BACKGROUND

Generally, this application relates to parking control systems for use with parking lots or parking areas (hereinafter, “parking lot” or more simply “lot”). Such parking lots can be operated commercially or publicly (e.g., by a municipality).

### SUMMARY

According to embodiments, a parking control system for authorizing parking of a vehicle within a geographic area includes: an integrated smart sign, including: a display configured to display information; at least one camera configured to receive image data, the image data including an imaged customer license plate number; communication circuitry configured to transmit signals to a remote processor; a near field communication (NFC) reader configured to receive a payment signal from one of a mobile device or a payment card, wherein the payment signal includes payment information; and a processor configured to communicate with the display, the at least one camera, and the communication circuitry, wherein the processor is configured to cause the display to display payment instructions including requesting a customer to enter an entered customer license plate number, and wherein the processor is configured to cause the communication circuitry to transmit the imaged customer license plate number, the entered customer license plate number, and the payment information to a remote processor. The parking control system may further include a remote processor, wherein the remote processor is configured to confirm that the imaged customer license plate number is the same as the customer license plate number and to effect payment if the license plate numbers are the same. The image data may further comprise customer presence information, wherein the processor is configured to update the display information based on whether a customer is detected in the customer presence information. The parking control system may further include a solar power source configured to provide power to the parking control system. The power source may be external to the integrated smart sign. The display may include electronic paper. The at least one camera may include a plurality of cameras pointed in different directions. A first one of the cameras may be configured to obtain image data including the imaged customer license plate number at an ingress of a parking lot at a first time, and a second one of the cameras may be configured to obtain image data including the imaged customer license plate number at an egress of a parking lot at a second time. The parking control system may be configured to determine from the first time and the second time a cost of parking. The processor may be configured to cause the display to display different information after a payment transaction has been completed.

According to embodiments, a parking control system for authorizing parking of a vehicle within a geographic area includes: an integrated smart sign, including: a display configured to display information; at least one camera configured to receive image data, the image data including an imaged customer license plate number; and communication circuitry configured to transmit signals to a remote processor; a processor configured to communicate with the display, the at least one camera, and the communication circuitry, wherein the processor is configured to cause the communication circuitry to transmit the imaged customer license plate number to a remote processor; and an app configured to operate on the customer's mobile device, wherein the app is configured to cause the mobile device to display payment instructions including requesting a customer to enter an entered customer license plate number and payment information, wherein the app is configured to cause the mobile device to transmit the entered customer license plate number and the payment information to a remote processor. The parking control system may further include a remote processor, wherein the remote processor is configured to confirm that the imaged customer license plate number is the same as the customer license plate number and to effect payment if the license plate numbers are the same. The image data may further include customer presence information, wherein the processor is configured to update the display information based on whether a customer is detected in the customer presence information. The parking control system may further include a solar power source configured to provide power to the parking control system. The power source may be external to the integrated smart sign. The display may include electronic paper. The at least one camera may include a plurality of cameras pointed in different directions. A first one of the cameras may be configured to obtain image data including the imaged customer license plate number at an ingress of a parking lot at a first time, and a second one of the cameras may be configured to obtain image data including the imaged customer license plate number at an egress of a parking lot at a second time. The parking control system may be configured to determine from the first time and the second time a cost of parking. The processor may be configured to cause the display to display different information after a payment transaction has been completed.

### BRIEF DESCRIPTION OF THE DRAWINGS

FIG. 1 illustrates a parking control system, according to embodiments.

FIG. 2 illustrates the parking control system of FIG. 1, as a vehicle and a mobile device enters a parking lot, according to embodiments.

FIG. 3 illustrates the parking control system of FIG. 1, when the vehicle is parked and the mobile device is in a payment region of the parking lot, according to embodiments.

FIG. 4 illustrates the parking control system of FIG. 1, when the vehicle and the mobile device exit the parking lot, according to embodiments.

FIGS. 5A and 5B illustrate a parking control system with an integrated smart sign, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

Parking lot operators may desire technology solutions to increase operational efficiency while minimizing fraud risks. Further, current payment or checkout processes may be invasive or time-consuming. Existing self-service ticketing/payment processes for parking can be cumbersome for customers by requiring them to download particular mobile applications and be registered to accomplish payment to authorize the customers'vehicles to park in the lot.

Existing self-service ticketing/payment process for parking may rely on payment triggering methods, such as scanning a QR code with a mobile device. Another example employs SMS for text-messaging a specific phone number and receiving back a URL link. In these examples, both the QR code or phone number can be displayed on physical signs and/or sticker signs near or in the parking lot's walking-exit areas.

Such systems are vulnerable to fraud, as fraudsters may replace the QR code or phone number with ones of their own. The customers then interact with the fraudsters'apps or websites, such that the fraudsters collect the customers'money. Lot operators may not realize the fraud for an extended period of time. Existing solutions may lack pro-active fraud protection, thereby requiring the lot operators to perform costly and in-person recurring inspections.

Other payment s as on-site physical payment terminals, may be expensive, require a large space, cluttering, or the like.

Further, existing solutions may lack of tools for proper real-time enforcement. Operators may not be able to afford real-time enforcement as current tools may be based on visual detection, and may be prohibitively expensive.

Further, existing solutions may allow for lost revenue due to parking overstays. It can be a challenge for operators to conciliate customers'payments, often made at the time of arrival/parking and are priced based on a customer-provided exit time (the exact time of leave and parking session duration). Operators may lose revenue when customers stay past the customer-provided exit time.

Further, the enforcement aspect of parking can be a challenging aspect of parking operations. Operators may rely on license plate recognition (LPR) to detect unauthorized vehicles on their parking lots and leverage license plate information to locate and bill an unauthorized vehicle's owner. However, this practice has been outlawed in several states and it has been scrutinized due customer privacy concerns as it may include tactics like unauthorized use of DMV data or non-consented data sharing among vendors including those in the car repossession industry to identify the vehicle's owner and send a bill.

Techniques described herein may address some or all of the aforementioned issues faced by lot operators and provide further advantages. Such techniques may improve and better secure self-service ticketing or payment processes. For example, the checkout process may not require pre-registration, and may be incentivized or effected after payment is completed.

Further, instead of using QR codes or phone numbers, payment triggering may be accomplished by a more secure mechanism, such as the use of NFC tags or other contactless technologies. Customers may be able to tap their NFC-enabled mobile devices to trigger or launch the checkout process, and this process can be controlled by a remote management processor, such as an application located in a cloud. Further, in the example of NFC tags, they can be enclosed and/or hidden from view, making them difficult to be tampered with. An attempt of fraudsters to install their own NFC tags (or similar) will conflict with the existing legitimate ones due the secure nature of the technology. Further, NFC tags (or similar) can be also connected to an LED or other light source, which illuminates when tag is read, thereby improving customer confidence that payment is being effected properly.

Additional fraud mitigation techniques are provided, such as cross-referencing techniques to identify potential unauthorized vehicles by detecting and/or tracking vehicles when they enter and/or exit the lot. Sensor(s), such as Bluetooth Low Energy (BLE) beacons may be used to implement such detection and/or tracking. Sensor(s) can send and/or receive wireless signals of a variety of potential types, including radio waves, optical waves (e.g., imaging, where the sensor(s) are cameras), ultrasonic waves or the like. The sensor(s) may detect the ingress and/or egress of vehicles and/or the moment they park, sending the information to a processor (e.g., part of or consisting of a cloud management system). The sensor(s) can operate to track the vehicle itself or mobile device(s) of the occupants of the vehicle. As an example, traffic beacons can be used detect the ingress of a vehicle and track the vehicle via tracking of a mobile device until the vehicle parks (e.g., the mobile device stops moving and/or is detected in a predetermined location of a parking spot). Further, sensor(s) can track or detect the mobile device when the mobile device when it is in a payment region proximate the payment triggering component(s). All or some of the tracking/detection information is sent, for example, in real-time by the sensor(s) to the processor. The processor may expect a ticket/payment session to be initiated/completed via guest checkout (e.g., a payment process triggered by tapping the mobile device on an NFC tag) with a pre-defined amount of time. The lack of a ticket/payment session can provoke the processor to notify the operator (e.g., in real time) to investigate possible physical tempering at location or the presence of an unauthorized vehicle.

The processor may further implement a “watchman” process, which may provide to the operator a list of the license tags of vehicles associated with a successful payment. Enforcement personnel can cruise the lot with a route indicating where potential offending vehicles are parked and validating existence of payment against the list of authorized vehicles. Enforcement personnel can monitor and/or be notified by the system on critical events (vehicle session expired or unauthorized vehicle) in order to take proper actions.

Further, techniques described herein may obtain otherwise lost revenue due to parking overstays. When customers initiate a payment, they may be providing their payment information and consent to be charged at the time of their effective exit from the parking lot. Instead of performing a standard payment transaction, the processor may perform a pre-authorization transaction, which can place a hold for a pre-defined amount on a customer's credit card for future debit. After the sensor(s) notify the processor that the customer's vehicle has departed, the processor can then perform a payment capture based on the pre-authorization transaction, thereby informing the proper amount to be charged. As such, operators may be able to properly and fully charge customers for their entire use of the service.

Further, privacy concerns (either legal or customer concerns) can be mitigated. For example, using BLE beacon sensor(s) as a limited and contained tracking mechanism has already been vetted in many instances to satisfy privacy concerns. Using BLE beacon(s), information collected during the tracking or detection of a vehicle occupant's mobile device does not identify the device's owner. However, the collected data is unique to a given mobile phone (e.g., a universally unique identifier (UUID)) and can be cross-referenced with legally/consented acquired personal information under either public or commercial records. Examples of cross-referenced information include the operator's name, email address(es), and/or phone number(s). Operators can leverage this information to collect payment after the vehicle has exited the lot.

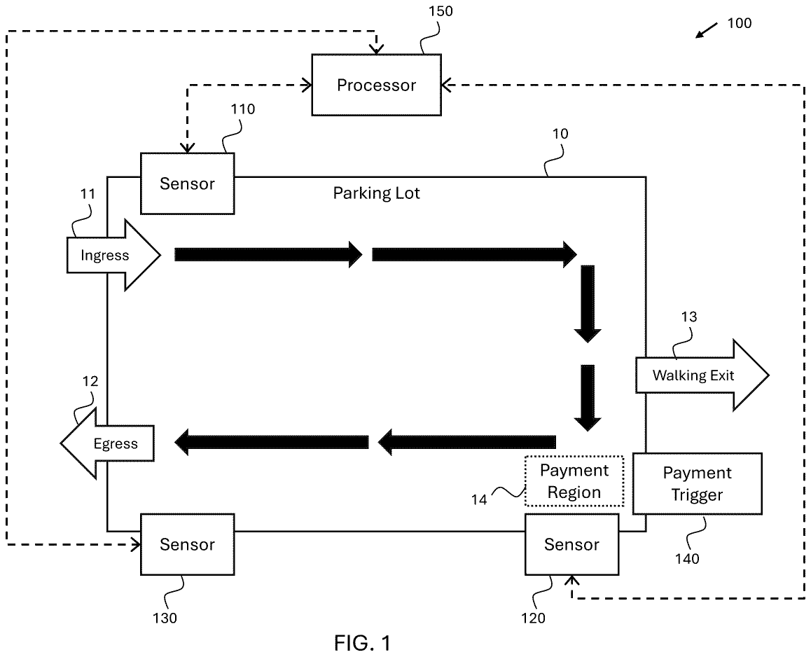

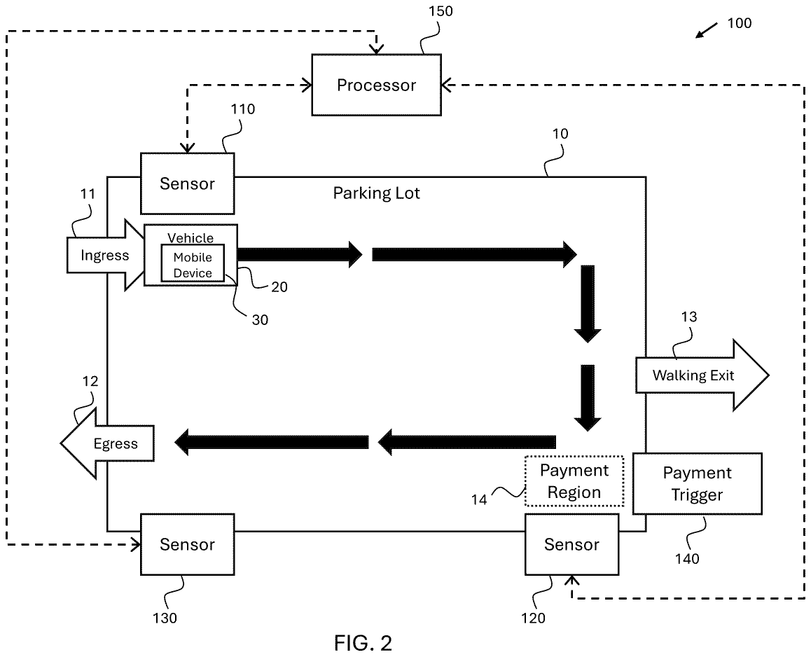

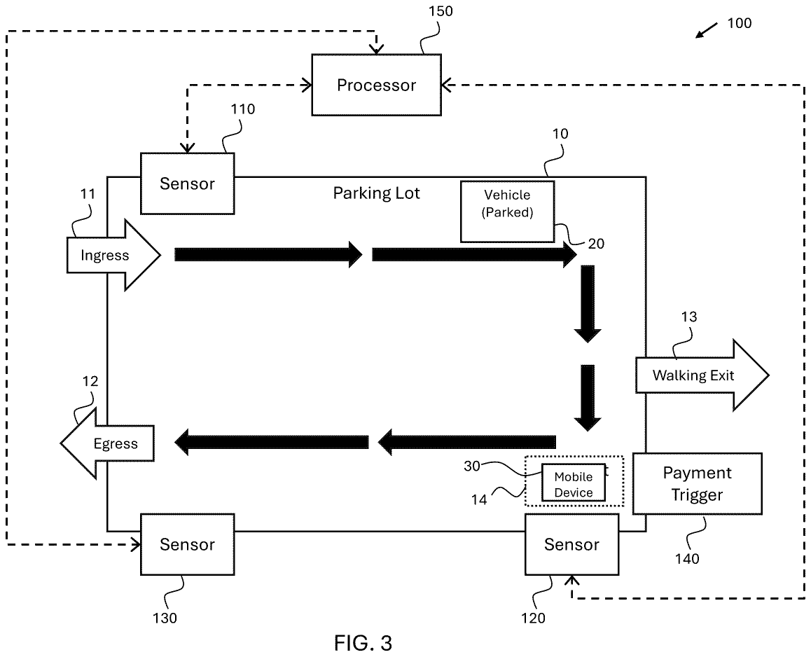

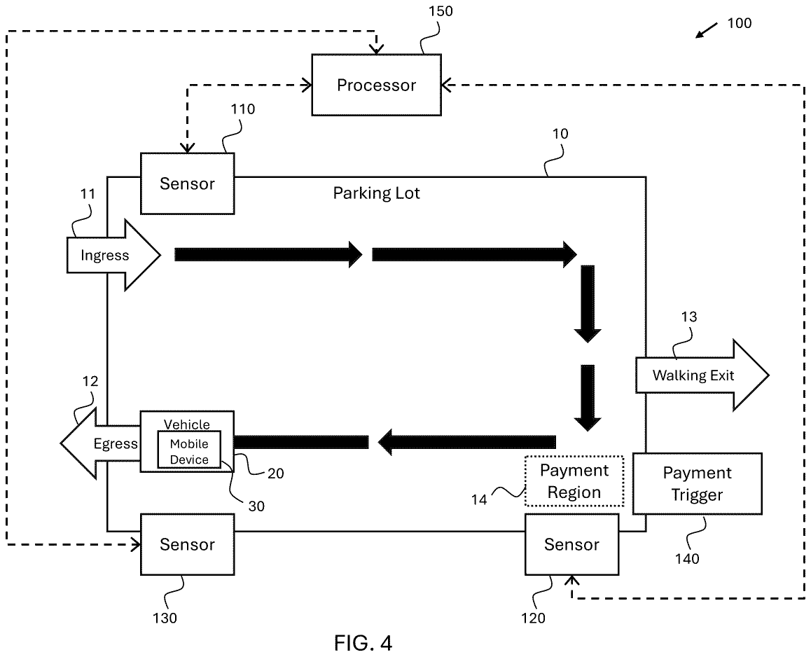

FIG. 1 illustrates a parking control system 100, according to embodiments. FIG. 2 illustrates the parking control system 100 of FIG. 1, as a vehicle 20 and a mobile device 30 enters the parking lot 10, according to embodiments. FIG. 3 illustrates the parking control system 100 of FIG. 1, when the vehicle 20 is parked and the mobile device 30 is in a payment region 14 of the parking lot 10, according to embodiments. FIG. 4 illustrates the parking control system 100 of FIG. 1, when the vehicle 20 and the mobile device 30 exit the parking lot 100, according to embodiments. FIGS. 2-4 show an exemplary flow of events when a vehicle parks at the lot 10.

As shown in FIG. 1, an exemplary parking control system 100 includes at least one sensor, and as depicted, three sensors 110, 120, 130 (although fewer or more sensors are contemplated). Further, the sensors 110, 120, 130 (or fewer or more) can be located at any suitable location in the lot 10, aside from where they are shown. The parking control system 100 further includes a payment trigger component 140 and a processor 150. The broken lines illustrate exemplary communications pathways, which may be wireless and/or wired. The thick black arrows illustrate exemplary flow paths for the vehicle 20 in the parking lot 10.

The exemplary parking lot 10 includes an ingress 11, egress 12, walking exit 13, and payment region 14. The parking lot 10 further includes parking spaces for the vehicle 20. While a lot 10 is depicted, similar principles can apply to other types of geographical areas, such as street-side parking areas. The lot 10 can be a ground lot or a multi-level lot. The vehicle 20 enters through the ingress 11 and exits via the egress 12. The occupant(s) can walk out of the lot 10 via the walking exit 13, ingress 11, egress 12, or other suitable locations of the lot 10. The payment region 14 is a region proximate the payment trigger component 140.

One or more of the sensors 110, 120, 130 may include BLE beacon(s), which may sense a mobile device 30 of an occupant of the vehicle 20. The location of the mobile device 30, as determined by the system 100, acts as a proxy for the location of the vehicle 20. While three sensors are shown, the system 100 may be implemented with fewer (one or two) or more sensors. Sensor 110 is located in the lot 10 in a location to detect/track the mobile device 30 at or near the ingress 11. Sensor 120 is located in the lot 10 in a location to detect/track the mobile device 30 at the payment region 14. Sensor 130 is located in the lot 10 in a location to detect/track the mobile device 30 at or near the egress 12. One or more sensors 110, 120, 130 can be implemented to track/detect the mobile device 30 at only the ingress 11, only the payment region 14, only the egress 12, the ingress 11 and payment region 14, the ingress 11 and egress 12, or the payment region 14 and the egress 12, and as such, embodiments of the system 100 do not require tracking/detection at all such locations. Further, tracking/detection can identify the location of the mobile device 30 at other areas of the lot, such as at a parking space or in the walking exit 13. Information obtained by the sensors 110, 120, 130 is communicated to the processor 140, e.g., wirelessly (such as via a cellular or WiFi or Bluetooth network).

The rate of travel of the mobile device 30 may be determined via tracking by the processor 150 and sensors 110, 120, 130, and it can be inferred (e.g., by assessing a change in received signal strength) whether the mobile device 30 is in a vehicle 20 based on the rate of travel (e.g., the mobile device 30 is moving above a pre-defined speed threshold). A sensor, such as a BLE sensor, can receive a Bluetooth signal from a nearby broadcasting Bluetooth device, such as the mobile device 30. In the case of a BLE sensor, it can identify the angle of the received signal in relation to the BLE sensor's antenna as well the strength of the signal. The signal strength can correlate to a physical distance. Generally, the stronger the signal, the closer the broadcasting device is to the sensor. With the signal strength and the incident angle of the broadcasted signal at the sensor, a processor can estimate the location of the broadcasting device. Similarly, acceleration and deceleration of the mobile device 30 may be determined, and that information as well can inform the processor 150 whether the mobile device 30 is in a vehicle 20. Also signal strength can be an indicator of whether the mobile device 30 is in a vehicle 20 (e.g., weaker signals may be detected when the mobile device 30 is in a vehicle 20). Signal strength can also be an indicator of a distance between the mobile device 30 and at least one of the sensors 110, 120, 130. The change in detected signal strength over time (or the signal strength at a single point in time) may be used for detection/tracking purposes, such as to determine an updated location (e.g., ingress 11, egress 12, walking exit 13, payment region 14, and/or parking space), speed, and/or acceleration of the mobile device 30. The location, speed, and/or acceleration may also be determined by techniques such as triangulating or assessing the signal strength at two or more of the sensors 110, 120, 130. Triangulation from multiple sensors may improve accuracy when determining location, speed, and/or acceleration.

The payment triggering component 140 may include an NFC tag that is tapped by a customer with the mobile device 30. By “tapped”, it is understood that this includes the action of bringing the mobile device 30 within a detectable distance of the payment triggering component 140 without necessarily having the mobile device 30 making physical contact with the payment triggering component 140. When the customer taps the mobile device 30 or otherwise interacts with the payment triggering component 140, this may cause the mobile device 30 to communicate with the processor 150. The processor 150 may be one or more processors working together to achieve a given process. When the processor 150 includes multiple processors, the processors may be in the same location (e.g., in the same housing or on the same chip) and/or may be distributed at locations remote from each other. In the case of multiple processors, they may communicate with each other to perform given processes. The mobile device 30 and the processor 150 may communicate with each other via cellular networks, WiFi networks, the Internet, intermediate components, and/or the like. The sensor 120 may detect the presence of the mobile device 30 in the payment region 14 when the mobile device 30 interacts with the payment triggering component 140. When the sensor 120 does not detect the presence of the mobile device 30 in the payment region 14, but the mobile device 30 was detected at the ingress 11, then an unauthorized parking event may be identified by the processor 150.

When the mobile device 30 first communicates with the processor 150 or payment trigger 140, the processor 150 may cause the mobile device 30 to present an interface to the customer to allow the customer to pay for parking and/or authorize the vehicle 20. Such an interface may be presented by a progressive web app (PWA) running on a browser. The customer can enter payment information (e.g., credit card or debit card information) and/or vehicle information (e.g., license plate number) into the mobile device 30 via the interface. After payment/authorization is completed, the processor 150 is notified and adds the vehicle 20 to a list of authorized vehicles. This list can be provided to the operator as part of the watchman process (e.g., provided to a mobile device associated with the operator). The list or a separate list may also indicate that a given number of vehicles 20 that have entered the lot 10 are not authorized to park in the lot 10, because the mobile device 30 has not made a payment and/or been detected in the payment region 14.

The sensor 130 can detect the mobile device 30 at the egress 12, and the processor 150 may infer from that that the vehicle 20 has exited the lot 10. The processor 150, upon inferring the egress of the vehicle 20, can determine an amount to charge the customer's credit card when a pre-authorization process is employed. Further, the processor 150 can determine whether the operator can take enforcement action, if the vehicle 20 was never authorized to park in the lot 10 and left without paying.

According to embodiments, parking control system for managing parking spaces within a geographic area (e.g., the lot 10) includes: a first sensor (e.g., one of sensors 110, 120, 130, such as a Bluetooth sensor) configured to receive a wireless signal (e.g., a wireless signal from the mobile device 30, such as a Bluetooth signal); a triggering device (e.g., the payment trigger component 140, such as an NFC tag) configured to trigger an authorization process to authorize a vehicle to park in a parking space within the geographic area; and a processor (e.g., the processor 150) in communication with the first sensor and the triggering device, wherein the processor is configured to: detect an approximate location of an object (e.g., the mobile device 30 and/or the vehicle 20) near or within the geographic area based on the wireless signal; detect a triggering event (e.g., the mobile device 30 being “tapped” or held proximate from the payment trigger component 140); cause the authorization process to be executed (e.g., by the processor 150 and/or the mobile device 30) upon detecting the triggering event, wherein the authorization process includes pre-authorizing a vehicle to park in a parking space within the geographic area; and execute (e.g., by the processor 150 and/or the mobile device 30) payment process to effect payment for a parking space. As part of the payment process, the cost for parking can be based at least in part on a duration between the initiation of the authorization process and when the mobile device has progressed away from the geographic area through the egress.

The wireless signal can be first emitted from the first sensor and then be reflected from the object to the first sensor (or another sensor). The payment process can include determining a cost for parking within the geographic area. The cost can be based at least in part on a type of credit card used for payment. The wireless signal can be emitted from a mobile device, wherein the wireless signal includes an identification characteristic (e.g., UUID) and a location characteristic (e.g., tracked/detected location of the mobile device, such as a location associated with a signal strength of the received wireless signal and/or a change in the signal strength), wherein the identification characteristic identifies the mobile device, and wherein the location characteristic provides an indication of a location of the mobile device.

The processor can be further configured to: assess the identification characteristic and the location characteristic from the wireless signal received by the first sensor and determine whether the mobile device is at or proximate to an ingress (e.g., ingress 11) of the geographic area; assess the identification characteristic and the location characteristic from the wireless signal received by the first sensor and determine whether the mobile device is at or proximate to the triggering device; and assess the identification characteristic and the location characteristic from the wireless signal received by the first sensor and determine whether the mobile device is at or proximate to an egress (e.g., 12) of the geographic area.

The system can include a second sensor (e.g., one of sensors 110, 120, 130) configured to receive the wireless signal; wherein the wireless signal is emitted from a mobile device, wherein the wireless signal includes an identification characteristic and a location characteristic, wherein the identification characteristic identifies the mobile device, and wherein the location characteristic provides an indication of a location of the mobile device. The processor can be further configured to: assess the identification characteristic and the location characteristic from the wireless signal received by the first and second sensor, and determine whether the mobile device is at or proximate to an ingress of the geographic area; assess the identification characteristic and the location characteristic from the wireless signal received by the first and second sensor, and determine whether the mobile device is at or proximate to the triggering device; and assess the identification characteristic and the location characteristic from the wireless signal received by the first and second sensor, and determine whether the mobile device is at or proximate to an egress of the geographic area. The location characteristic of the wireless signal can include a signal strength of the wireless signal. The processor can be further configured to assess a change in the signal strength over time to estimate whether the mobile device is in a vehicle. The processor can be further configured to assess a change in the signal strength over time to determine whether the mobile device has entered the geographic area through the ingress. The processor can be further configured to assess a change in the signal strength over time to determine whether the mobile device is at the triggering device. The processor can be further configured to assess a change in the signal strength over time to determine whether the mobile device has exited the geographic area through the egress. The triggering event can be initiated by the mobile device. The payment process can include determining a cost for parking within the geographic area. The cost for parking can be based at least in part on a duration between the initiation of the authorization process and when the mobile device has progressed away from the geographic area through the egress. The cost for parking can be based at least in part on a type of credit card used for payment.

The system can include a second sensor configured to receive the wireless signal and a third sensor configured to receive the wireless signal. The wireless signal can be emitted from a mobile device, wherein the wireless signal includes an identification characteristic and a location characteristic, wherein the identification characteristic identifies the mobile device, and wherein the location characteristic provides an indication of a location of the mobile device. The processor can be configured to assess the identification characteristic and the location characteristic from the wireless signal received by the first, second, and third sensors, and determine whether the mobile device is at or proximate to an ingress of the geographic area; assess the identification characteristic and the location characteristic from the wireless signal received by the first, second, and third sensors, and determine whether the mobile device is at or proximate to the triggering device; and assess the identification characteristic and the location characteristic from the wireless signal received by the first, second, and third sensors, and determine whether the mobile device is at or proximate to an egress of the geographic area. The location characteristic of the wireless signal can include a signal strength of the wireless signal. The processor can further be configured to assess a change in the signal strength over time to estimate whether the mobile device is in a vehicle. The processor can be further configured to assess a change in the signal strength over time to determine whether the mobile device has entered the geographic area through the ingress. The processor can be further configured to assess a change in the signal strength over time to determine whether the mobile device is at the triggering device. The processor can be further configured to assess a change in the signal strength over time to determine whether the mobile device has exited the geographic area through the egress. The triggering event can be initiated by the mobile device. The payment process can include determining a cost for parking within the geographic area. The cost for parking can be based at least in part on a duration between the initiation of the authorization process and when the mobile device has progressed away from the geographic area through the egress. The cost for parking can be based at least in part on a type of credit card used for payment. The first, second, and third sensors can be Bluetooth sensors and the wireless signal is a Bluetooth signal.

The processor can be further configured to export a list of vehicles (e.g., send a file including the list to a mobile device or other computing device associated with the operator) permitted to park in the geographic area.

The processor can be further configured to notify the mobile device that a parking session is expiring, and inquire if the user would like to make an additional payment to extend the duration of authorized parking. If the user agrees, then the processor may facilitate a transaction with the user to extend the time for parking in exchange for a payment.

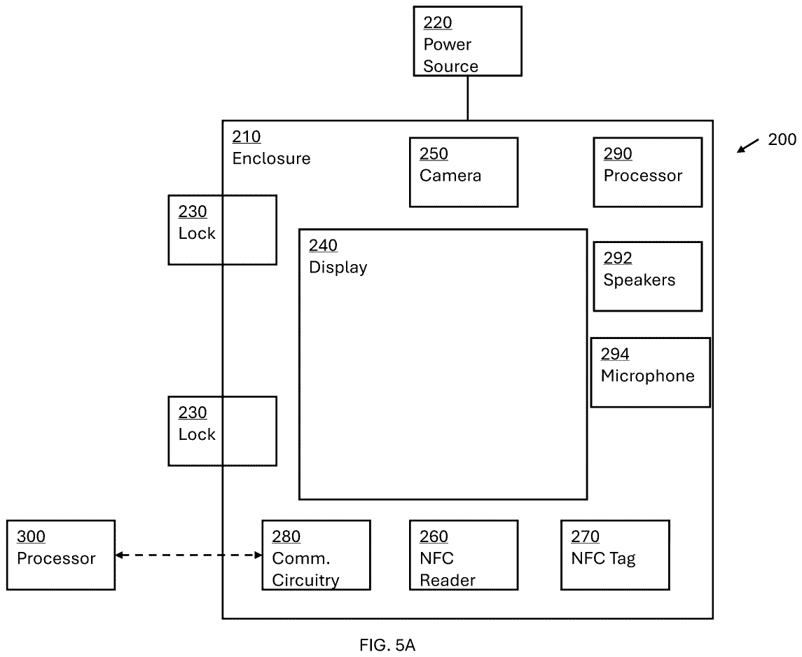

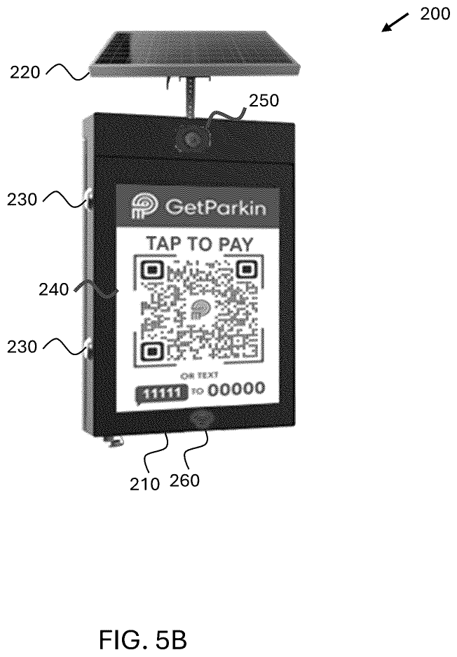

According to embodiments, an integrated smart sign 200 can be provided for the lot 10. An exemplary integrated smart sign 200 is shown in FIGS. 5A and 5B. The integrated smart sign 200 may be used in conjunction with or separate from the system 100 and the various techniques described herein associated with the system 100. The integrated smart sign 200 may be used in conjunction with the customer's mobile device 30. The integrated smart sign 200 may be used in conjunction with the processor 150, for example, as part of a parking control system. In embodiments, the sensors 110, 120, 130 are not used with the integrated smart sign 200.

The integrated smart sign 200 may include an enclosure 210, lock(s) 230, a display 240, camera(s) 250, an NFC reader 260, an NFC tag 270, communications circuitry 280, speakers 292, microphone 294, and/or a processor 290. The enclosure 210 may be a weatherproof casing for the integrated smart sign 200 to protect the components integrated therein from exposure to elements. In embodiments, the enclosure 210 houses all of the aforementioned components, except for possibly the lock(s) 230 and/or a power source 220 or portions thereof. The enclosure 210 may have a door, a lid, or other type of opening that opens and is optionally secured by the lock(s) 230. An authorized person can access the interior of the enclosure 210 by unlocking the lock(s) 230.

The integrated smart sign 200 may include a power source 220, or the power source 220 may be external to the integrated smart sign 200. The power source 220 may include a solar cell (as shown in FIG. 5B) and a rechargeable battery. The rechargeable battery may be located in the integrated smart sign 200 or external to the integrated smart sign 200. Conductors can extend from the rechargeable battery to power-drawing components in the integrated smart sign 200 via a power bus.

The display 240 displays information to customers, such as, for example, parking instructions, parking rates, directions, facility information, advertising, or the like. The display 240 may be color or not. The display 240 may be backlit or not. In an embodiment, the display 240 includes electronic paper and is not backlit. The display 240 may be viewable through an aperture in a front panel of the enclosure 210. The display 240 may be a touch screen display.

At least one camera 250 may be located above the display 240. The lens(es) of the camera(s) 250 may be located behind a clear plate at an aperture through a front panel of the enclosure 210, such that the camera(s) 250 can capture images outside of the enclosure 210. Camera(s) 250 may be located on the front and/or sides of the integrated smart sign 200. If on the sides, lens(es) of the camera(s) 250 may be located behind a clear plate at an aperture through a side panel of the enclosure 210, such that the camera(s) 250 can capture images outside of the enclosure 210.

In the case that multiple cameras 250 are used, some camera(s) 250 may be positioned and/or oriented to obtain license plate image data and dedicated to this function, while other camera(s) 250 may be positioned and/or oriented to obtain customer presence image data and dedicated to this function, as will be further discussed below. In other words, the cameras 250 can be positioned and/or oriented such that they point in different directions. An operator may be able to adjust the orientation of the camera(s) 250 according to the needs for an integrated smart sign 200 at a given location of a parking facility. The orientation of the camera(s) 250 may be performed physically by an installer, or may be performed electronically via motors controlled by the processor 290 or other means (e.g., remote control).

The NFC reader 260. The NFC reader 260 may be located below the display 240. The NFC reader 260 may be completely enclosed by the enclosure 210. Artwork may be located on the front panel of the enclosure 210 to indicate to the customer where to place the mobile device for scanning such that it is successfully scanned by the NFC reader 260. The NFC reader 260 can read a customer's payment card information from the mobile device.

The NFC tag 270 is scannable by the mobile device. The NFC tag 270 may be completely enclosed by the enclosure 210. The NFC tag 270 may encode a URL. The mobile device may be able to scan the NFC tag 270 and read the URL, and open the link. The link may trigger a mobile payment process on the mobile device similar to the one discussed above.

The communication circuitry 280 can communicate data to devices external to the integrated smart sign 200. The communication circuitry 280 may be completely enclosed by the enclosure 210. Such communication can be wired and/or wireless (e.g., cellular, WiFi, or Bluetooth network). The communication circuitry 280 may communicate information to/from a remote device, such as a processor 300. The processor 300 may be similar to the processor 150. Such information transmitted to, for example, the processor 300 may include raw information, such as image data (also inclusive of video data) from the camera(s) 250 and payment card information from the NFC reader 260. Such information may also include processed information, such as information processed by the processor 290 (e.g., processed image data).

The speaker(s) 292 can play audio to the customer. For example, the speaker(s) 292 can announce instructions and whether payment was successful or unsuccessful. The speaker(s) 292 may announce other types of information, such as advertising information or information about the parking facility. The microphone 294 can receive input, e.g., voice input, from the customer. The system (either the processor 290 or the processor 300) can process the voice input and determine a response, which is returned and presented to the customer, either through the speaker(s) 292 or the display 240.

The processor 290 may communicate with and control operations of the electronic components of the integrated smart sign 200, including the operations disclosed herein, as will be understood. The processor 290 may be one or more processors working together to achieve a given process. The processor 290 can execute a set of instructions stored on a computer-readable medium to effect the processes discussed herein. The processor 290 can communicate information to/from the processor 300 via the communication circuitry 280. The processors 290, 300 may operate together or separately to achieve the functions described herein. Collectively, the processors 290, 300 are disclosed as the “processor(s)”, although a given processing operation may be performed by one or the other alone.

In operation, the customer experience and parking control system may operate as follows. Initially, the customer's vehicle enters the parking lot through the parking lot ingress. The camera(s) 250 in the integrated smart sign 200 may be constantly scanning the environment. The image data can include an imaged customer license plate number. The camera(s) 250 may receive image data and communicate it with the processor 290. The processor(s) 290, 300 may process the image data. The processor(s) 290, 300 may determine from the image data a license plate number of a vehicle. The processor(s) 290, 300 can extract the license plate number (or information) from the image data, for example, by optical character recognition. Because the license plate number is encoded in the image data, even if the processor 290 does not extract the license plate number from the image data but only transmits the image data to the processor 300, the processor 290 can transmit the license plate information to the processor 300, whether extracted from the image data or not.

The customer then exits the vehicle and approaches the integrated smart sign 200 to perform payment. The processor(s) 290, 300 can also, from the image data, determine customer presence information for when a customer is in proximity to the integrated smart sign 200. The customer may be in proximity to the integrated smart sign 200 when the customer is between zero and 5 feet from the integrated smart sign 200. The sensitivity of the proximity detection may be adjustable, for example, by adjusting image processing algorithms performed by the processor(s) 290, 300, such as the sensitivity of motion detection algorithms. Such adjustment may be performed by the system operator.

Once the presence of a customer at the integrated smart sign 200 is determined, the processor(s) 290, 300 can cause the display 240 to update the displayed content, for example, from advertising content to payment instructions.

Payment may be effected in different ways. In a first way to effect payment, the display 240 can instruct the customer to use the mobile device to scan the NFC tag 270 to open a link in a browser or an app for payment. The display 240 can inform the customer the location of the NFC tag 270 on the integrated smart sign 200. The display 240 may also update the displayed content to display a QR code that the customer can scan with the mobile device. This may provide the option to open a link in a browser or app for payment. The display 240 may also provide a number to text, which may generate a response with a link to open in a browser or an app for payment or an associated function.

The app is executed on the mobile device by executing a set of computer-readable instructions by a processor in the mobile device. The app performs the following processes by causing the mobile device to perform operations and communicating with the processor 300. After the customer launches the payment app on the mobile device, the payment app queries the customer to enter their license plate number (an entered customer license plate number), select an exit time, and perform payment through the payment app. The entered license plate number entered through the payment app is confirmed with (is the same as) the imaged license plate number (or one of a list of license plate numbers) recognized through scanning by the processor 300. If the license plate numbers do not match, then an error message may be generated to the customer through the app, and the customer may be instructed to enter the license plate number again. Once the process is successful, the processor 300 registers that payment in association with the license plate number has been successfully effected.

In a second way to effect payment, the customer uses the integrated smart sign 200 to effect payment (i.e., not an app on the mobile device). The display 240 can prompt the customer to interact with the display 240 (e.g., touch the display 240 anywhere or in a specific location) to begin the process. The display 240 prompts the customer to enter the license plate number and select an exit time by touching the display 240. As with the previous method, the entered and imaged license plate numbers are compared to see if they are the same, and the process either continues or an error message or instructions to re-enter the license plate number are presented to the customer. The display 240 then prompts the customer to scan (or “tap”) the mobile device or a payment card at the NFC reader 260. The display 240 can inform the customer where the NFC reader 260 is located on the integrated smart sign 200 (e.g., with arrows). A map or artwork on the front panel of the integrated smart sign 200 can also indicate the location of the NFC reader 260. The integrated smart sign 200 can also include a swipe/insert to pay integrated device to receive payment. The payment signal received from the mobile device or payment card at the NFC reader 260 includes payment information, which the processor 290 transfers to processor 300, where payment is effected in association with the entered (and optionally detected) license plate number.

Through either payment process, the customer may be queried for a phone number and/or email address. The customer can optionally provide this information. This information can be used to provide an optional receipt via email or text (SMS). The customer can optionally request a receipt.

Once the payment process is complete, the processor(s) 290, 300 can cause the display 240 to update the information displayed. For example, the new information can include advertising content or local information, such as information about the parking lot (e.g., a map) or local facilities (e.g., attractions, restaurants, etc.).

When the customer's vehicle exits the parking lot, the camera(s) 250 in conjunction with the processor(s) 290, 300 can recognize the license plate number at the parking lot egress. The processor 300 can determine whether the customer's vehicle has overstayed its authorized duration based on the amount paid, payment time and/or ingress time, and egress time.

When a vehicle has overstayed, the parking control system may have an automated extension feature. During payment, the customer may have been prompted to authorize additional charges for overstaying. The parking control system can automatically charge the customer's payment card for any overstay charges according to the location's rate schedule (hour, period, and/or the like). On the other hand, the parking control system may not have an automated extension feature. To facilitate extended authorization, however, the customer can receive an email and/or text message (SMS) of a notification of expiration of authorization in advance of expiration, for example, 15 minutes in advance of the expiration time. The notification may provide a link for the customer to buy more time to extend authorization.

Some or all of the operations described herein may be performed using a computer or other processor having hardware, software, and/or firmware (e.g., processor 150). The various processes may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These processes will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A parking control system for authorizing parking of a vehicle within a geographic area, the parking control system comprising:
an integrated smart sign, including:
a display configured to display information;
at least one camera configured to receive image data, the image data including an imaged customer license plate number;
communication circuitry configured to transmit signals to a remote processor;
a near field communication (NFC) reader configured to receive a payment signal from one of a mobile device or a payment card, wherein the payment signal includes payment information; and
a processor configured to communicate with the display, the at least one camera, and the communication circuitry,
wherein the processor is configured to cause the display to display payment instructions including requesting a customer to enter an entered customer license plate number, and
wherein the processor is configured to cause the communication circuitry to transmit the imaged customer license plate number, the entered customer license plate number, and the payment information to a remote processor.

2. The parking control system of claim 1, further comprising a remote processor, wherein the remote processor is configured to confirm that the imaged customer license plate number is the same as the customer license plate number and to effect payment if the license plate numbers are the same.

3. The parking control system of claim 1, wherein the image data further comprises customer presence information, wherein the processor is configured to update the display information based on whether a customer is detected in the customer presence information.

4. The parking control system of claim 1, further comprising a solar power source configured to provide power to the parking control system.

5. The parking control system of claim 4, wherein the power source is external to the integrated smart sign.

6. The parking control system of claim 1, wherein the display comprises electronic paper.

7. The parking control system of claim 1, wherein the at least one camera comprises a plurality of cameras pointed in different directions.

8. The parking control system of claim 7, wherein a first one of the cameras is configured to obtain image data including the imaged customer license plate number at an ingress of a parking lot at a first time, and a second one of the cameras is configured to obtain image data including the imaged customer license plate number at an egress of a parking lot at a second time.

9. The parking control system of claim 8, wherein the parking control system is configured to determine from the first time and the second time a cost of parking.

10. The parking control system of claim 1, wherein the processor is configured to cause the display to display different information after a payment transaction has been completed.

11. A parking control system for authorizing parking of a vehicle within a geographic area, the parking control system comprising:
an integrated smart sign, including:
a display configured to display information;
at least one camera configured to receive image data, the image data including an imaged customer license plate number; and
communication circuitry configured to transmit signals to a remote processor;
a processor configured to communicate with the display, the at least one camera, and the communication circuitry,
wherein the processor is configured to cause the communication circuitry to transmit the imaged customer license plate number to a remote processor; and
an app configured to operate on the customer's mobile device,
wherein the app is configured to cause the mobile device to display payment instructions including requesting a customer to enter an entered customer license plate number and payment information,
wherein the app is configured to cause the mobile device to transmit the entered customer license plate number and the payment information to a remote processor.

12. The parking control system of claim 11, further comprising a remote processor, wherein the remote processor is configured to confirm that the imaged customer license plate number is the same as the customer license plate number and to effect payment if the license plate numbers are the same.

13. The parking control system of claim 11, wherein the image data further comprises customer presence information, wherein the processor is configured to update the display information based on whether a customer is detected in the customer presence information.

14. The parking control system of claim 11, further comprising a solar power source configured to provide power to the parking control system.

15. The parking control system of claim 14, wherein the power source is external to the integrated smart sign.

16. The parking control system of claim 11, wherein the display comprises electronic paper.

17. The parking control system of claim 11, wherein the at least one camera comprises a plurality of cameras pointed in different directions.

18. The parking control system of claim 17, wherein a first one of the cameras is configured to obtain image data including the imaged customer license plate number at an ingress of a parking lot at a first time, and a second one of the cameras is configured to obtain image data including the imaged customer license plate number at an egress of a parking lot at a second time.

19. The parking control system of claim 18, wherein the parking control system is configured to determine from the first time and the second time a cost of parking.

20. The parking control system of claim 1, wherein the processor is configured to cause the display to display different information after a payment transaction has been completed.
